(19) United States
(12) Patent Application Publication
(10) Pub. No.: US 2014/0168108 A1
(43) Pub. Date: Jun. 19, 2014

(54) ELECTRONIC DEVICE AND METHOD FOR PROVIDING TACTILE STIMULATION

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: SHANG-QING ZHOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/752,787

(22) Filed: Jan. 29, 2013

(30) Foreign Application Priority Data
Dec. 17, 2012 (CN) 201210548085.8

(51) Int. Cl. G06F 3/01

(52) U.S. Cl. CPC G06F 3/016
USPC 345/173

(57) ABSTRACT

A method for providing tactile stimulation is applied in an electronic device. The electronic device includes a touch-sensitive screen and a tactile stimulation multilayer connected to the touch-sensitive screen. The tactile stimulation multilayer includes a number of electrodes. The method includes follow steps of: detecting whether one event of a game installed on the electronic device is triggered when the game is running; determining touched positions according to touch signals from the touch-sensitive screen if one event of the running game is triggered; determining a number of electrodes corresponding to the touched positions according to a first relationship between touchable positions and the electrodes, and determining an electrical data corresponding to the triggered event according to a second relationship between different events and the electrical data; and energizing the determined electrodes according to the determined electrical data.

### BACKGROUND

1. Technical Field

The present disclosure relates to electronic devices, and particularly to an electronic device and a method for providing tactile stimulation adapted for the electronic device.

2. Description of Related Art

Many electronic devices, such as mobile phones, tablet computers, and multimedia players, employ touch-sensitive screens as input interfaces. When a user plays a game installed in an electronic device having a touch-sensitive screen, he or she can select the virtual icons displayed on the touch-sensitive screen to operate the game. However, the touch-sensitive screen does not provide tactile feedback which has a travel distance for a keystroke when pressed to the user as a conventional keyboard does.

The technology of enabling the touch-sensitive screen to provide tactile feedback is realized by delivering an electrosensory sensation in response to a touch operation on the touch-sensitive screen. However, there are almost no developments on how this kind of tactile feedback can be applied with various games in an electronic device to bring a new level of tactile experience to the user.

Therefore, what is needed is a means to solve the problem described above.

### BRIEF DESCRIPTION OF THE DRAWINGS

Many aspects of the present disclosure should be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a perspective view of a touch-sensitive screen included in an electronic device, in accordance with an exemplary embodiment.

FIG. 2 is a perspective view of a tactile stimulation multilayer connected to the touch-sensitive screen of FIG. 1, in accordance with an exemplary embodiment.

FIG. 3 is a block diagram of a tactile stimulation system applied to the electronic device of FIG. 1, in accordance with an exemplary embodiment.

FIG. 4 is a flowchart of a method for providing tactile stimulation, in accordance with an exemplary embodiment.

### DETAILED DESCRIPTION

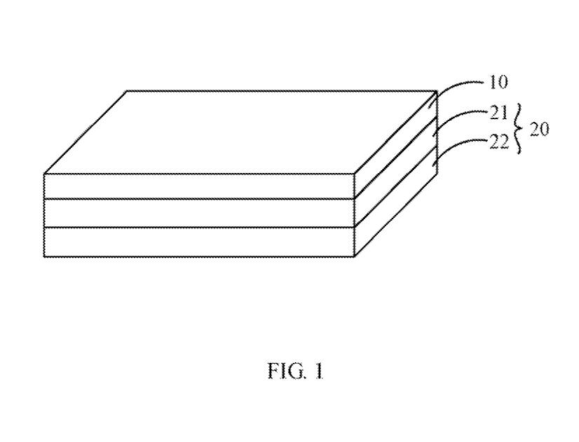

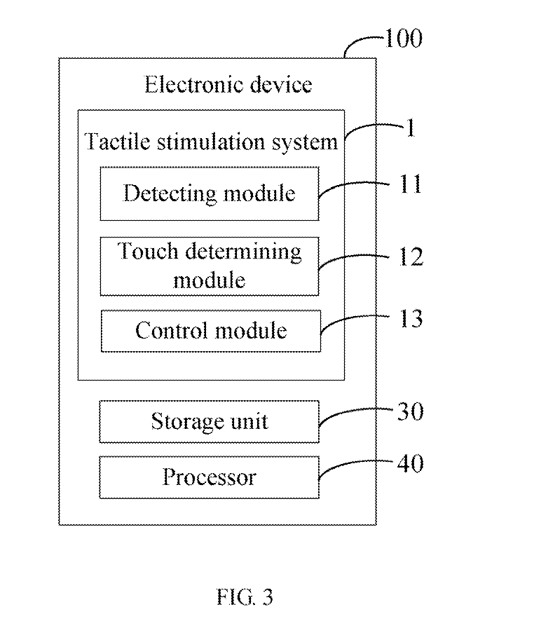

FIG. 1 is a perspective view of a touch-sensitive screen 10 of an electronic device 100 according to an exemplary embodiment. The electronic device 100 may be a mobile phone, a tablet computer, or a multimedia player for example. At least one game is installed on the electronic device 100. A tactile stimulation multilayer 20 is connected to the screen 10, and is arranged above or under the screen 10. The multilayer 20 includes a number of electrodes 220 (further shown in FIG. 3) which can be independently controlled. The electronic device 100 further includes a storage unit 30 and a processor 40 (further shown in FIG. 3). The storage unit 30 stores a first relationship between a number of touchable positions of the screen 10 and the electrodes 220. Each touchable position corresponds to one electrode 220. The storage unit 30 further stores a tactile stimulation system 1. The system 1 includes a variety of modules executed by the processor 40 to provide the functions of the system 1. In the embodiment, the system 1 is executed by the processor 40 to detect touch operation on the screen 10 made by a body member to be stimulated (e.g., a finger) and employ position information of the touch operation to energize the corresponding electrode 220 in the multilayer 20 to provide tactile stimulation. A detail description of the tactile stimulation multilayer 20 will be described as follows.

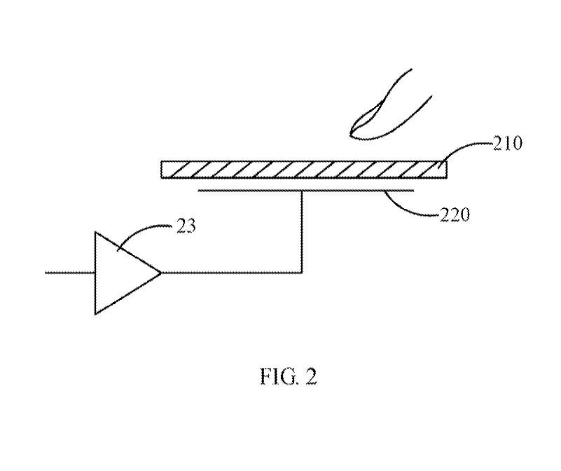

FIG. 2 shows that the multilayer 20 includes an insulation layer 21 and an electrode layer 22. The electrodes 220 are included in the electrode layer 22. The electrodes 220 are connected to a power supply unit 23, and can be independently energized via the power supply unit 23. The insulation layer 21 includes a number of insulators 210, and each insulator 210 corresponds to one electrode 220. In the embodiment, the multilayer 20 is arranged under the screen 10, and the insulation layer 21 is arranged between the multilayer 20 and the electrode layer 22. Furthermore, when a body member which is a relatively good insulator when dry touches the multilayer 20, the body member and the multilayer 20 cooperatively form a capacitor. When the system 1 determines the position of the body member on the screen 10 and energizes the electrode 220 corresponding to the determined position via the power supply unit 23, static electrical charges are generated on the body member because of a capacitive coupling between the determined electrode 220 and the body member, and a tactile stimulation is delivered to the body member.

FIG. 3 shows that in the embodiment, the system 1 includes a detecting module 11, a touch determining module 12, and a control module 13.

The detecting module 11 detects whether one event of a game installed on the electronic device 100 is triggered when the game is running. The game includes a variety of predetermined events that a user interacts with when operating the application. Take a car racing game for example, the car may interact with events including lane departure, and collisions with other cars or track obstacles. Each event corresponds to one electrical data, and the electrical data is the amplitude or frequency of electrical current energizing the electrodes 220. A second relationship between different events and electrical data is stored in the storage unit 30.

The touch determining module 12 determines touched positions according to touch signals from the screen 10 if one event of the running game is triggered. Specifically, each time a touch operation is executed on the screen 10, different touched positions of the screen 10 may be simultaneously touched, thus, each time when a touch operation is detected, position information of a number of touched positions of the touch operation may be obtained.

The control module 13 determines one or more electrodes 220 corresponding to the touched positions according to the first relationship between the touchable positions and the electrodes 220, determines the electrical data corresponding to the triggered event according to the second relationship between different events and electrical data, and energizes the determined electrodes 220 via the power supply unit 23 according to the determined electrical data. Thus, a tactile stimulation is provided to the body member touching the screen 10 by making the triggered event in a simulative scene come alive. For example, when the car in a car racing game controlled by the body member collides with other cars, the touched positions of the body member may be the place where the collision happened. Then, the control module 13 energizes the electrodes 220 corresponding to the touched positions of the body member via the power supply unit 23 with electrical current of great amplitude, thereby a strong tactile stimulation is provided to the body member like a traffic collision is happening in a live racing.

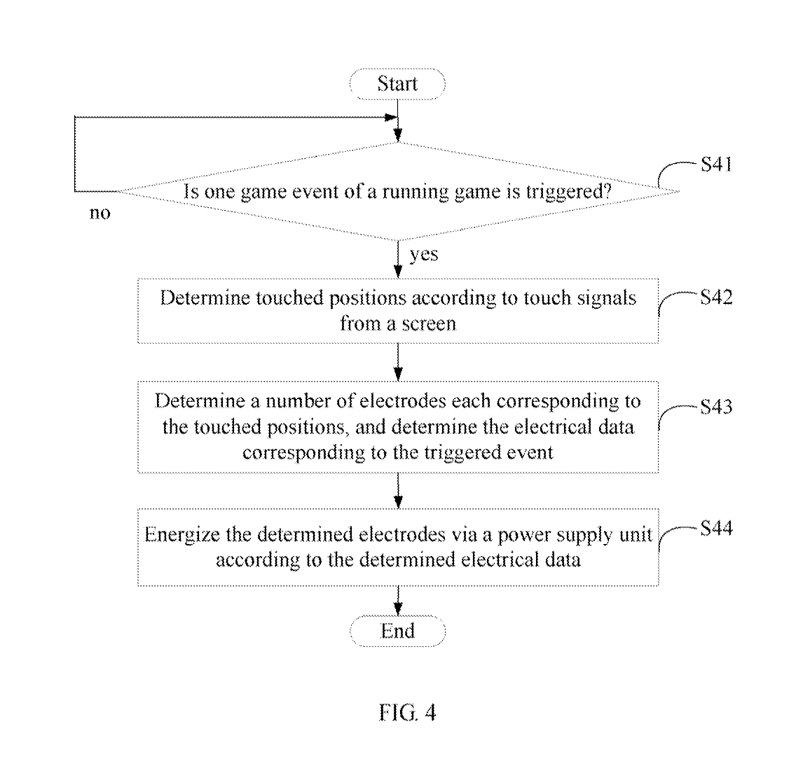

FIG. 4 is a flowchart of a method for providing tactile stimulation, in accordance with an exemplary embodiment.

In step S41, the detecting module 11 detects whether one event of a game installed on the electronic device 100 is triggered when the game is running, if yes, the procedure goes to step S42; otherwise, the procedure goes back to step S41.

In step S42, the touch determining module 12 determines touched positions according to touch signals from the screen 10.

In step S43, the control module 13 determines one or more electrodes 220 corresponding to the touched positions according to the first relationship between the touchable positions and the electrodes 220, and determines the electrical data corresponding to the triggered event according to the second relationship between different events and the electrical data.

In step S44, the control module 13 energizes the determined electrodes 220 via the power supply unit 23 according to the determined electrical data.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a touch-sensitive screen;
a tactile stimulation multilayer connected to the touch-sensitive screen, the tactile stimulation multilayer comprising a plurality of electrodes, each touchable position of the touch-sensitive screen corresponding to one of the electrodes;
a storage unit storing a plurality of modules; and
a processor to execute the plurality of modules;
wherein the plurality of modules comprises:
a detecting module to detect whether one event of a game installed on the electronic device is triggered when the game is running, each event corresponding to one electrical data;
a touch determining module to determine touched positions according to touch signals from the touch-sensitive screen if one event of the running game is triggered ; and
a control module to determine one or more of the plurality of electrodes corresponding to the touched positions according to a first relationship between the touchable positions and the electrodes stored in the storage unit, determine an electrical data corresponding to the triggered event according to a second relationship between different events and the electrical data stored in the storage unit, and energize the determined electrodes via a power supply unit according to the determined electrical data.

2. The electronic device of claim 1, wherein the electrical data is the amplitude or frequency of electrical current energizing the electrodes.

3. A method for providing tactile stimulation applied in an electronic device, the electronic device comprising a touch-sensitive screen and a tactile stimulation multilayer connected to the touch-sensitive screen, the tactile stimulation multilayer comprising a plurality of electrodes, the method comprising:
detecting whether one event of a game installed on the electronic device is triggered when the game is running, each event corresponding to one electrical data;
determining touched positions according to touch signals from the touch-sensitive screen if one event of the running game is triggered;
determining one or more of the plurality of electrodes corresponding to the touched positions according to a first relationship between touchable positions and the electrodes stored in the electronic device, and determining an electrical data corresponding to the triggered event according to a second relationship between different events and the electrical data stored in the electronic device; and
energizing the determined electrodes via a power supply unit according to the determined electrical data.

4. A storage medium storing a plurality of modules, the plurality of modules comprising instructions executable by a processor of an electronic device to perform a method for providing tactile stimulation, the electronic device comprising a touch-sensitive screen and a tactile stimulation multilayer connected to the touch-sensitive screen, the tactile stimulation multilayer comprising a plurality of electrodes, the method comprising:
detecting whether one event of a game installed on the electronic device is triggered when the game is running, each event corresponding to one electrical data;
determining touched positions according to touch signals from the touch-sensitive screen if one event of the running game is triggered;
determining one or more of the plurality of electrodes corresponding to the touched positions according to a first relationship between touchable positions and the electrodes stored in the electronic device, and determining an electrical data corresponding to the triggered event according to a second relationship between different events and the electrical data stored in the electronic device; and
energizing the determined electrodes via a power supply unit according to the determined electrical data.
